(19) United States
(12) Patent Application Publication
(10) Pub. No.: US 2012/0064469 A1
(43) Pub. Date: Mar. 15, 2012

(54) VERTICAL-TYPE HEAT TREATMENT APPARATUS, AND CONTROL METHOD FOR SAME

(75) Inventors: Koji YOSHII, Oshu-Shi (JP); Tatsuya Yamaguchi, Sapporo-Shi (JP); Wenling Wang, Oshu-Shi (JP); Takanori Saito, Oshu-Shi (JP)

(73) Assignee: Tokyo Electron Limited, Minato-Ku (JP)

(21) Appl. No.: 13/221,209

(22) Filed: Aug. 30, 2011

(30) Foreign Application Priority Data
Sep. 7, 2010 (JP) 2010-200201

(51) Int. Cl. F27D 19/00; F27D 7/00; F27D 11/02; F27B 1/24

(52) U.S. Cl. 432/24; 432/42; 432/48; 432/49

(57) ABSTRACT

A heat treatment apparatus and control method enabling the apparatus to settle down the internal temperature of a treating vessel to a target temperature accurately and quickly. The apparatus includes a furnace body with a heater on an inner circumferential surface thereof, a treating vessel disposed inside the furnace body, a cooling medium supply blower and cooling medium release blower connected to the furnace body, and a temperature sensor provided inside the treating vessel. A signal from the temperature sensor is sent to a heater output computing unit of a controller. The computing unit determines a heater output level to be obtained during temperature regulation with the heater only, the heater output level being based on a preset temperature that has been determined by a temperature determining unit and temperature detected by the temperature sensor. A blower output computing unit activates blower output based on the heater output level.

### CROSS-REFERENCE TO RELATED APPLICATIONS

This patent application benefits from Japanese Patent Application No. 2010-200201, filed on Sep. 7, 2010, the disclosure of which is hereby incorporated by reference in its entirety.

### BACKGROUND OF THE INVENTION

1. Field of the Invention

The present invention relates to a vertical-type heat treatment apparatus and a control method for the same.

2. Description of the Related Art

During the manufacture of semiconductor devices, various types of heat treatment apparatuses are used to conduct oxidizing, diffusing, chemical vapor deposition (CVD), annealing, and/or other heat treatment processes, upon materials to be heat-treated, such as semiconductor wafers. Among these apparatuses is known a vertical-type heat treatment apparatus capable of heat-treating a large number of sheets at a time. This conventional vertical-type heat treatment apparatus includes a quartz-made treating vessel having an opening in its lower portion, a lid for blocking/unblocking the opening in the treating vessel, a holder provided on the lid, for holding in a vertical direction at predetermined spatial intervals, a plurality of objects to be processed, and a furnace body surrounding the treating vessel and including a heater to heat the target materials after loading of the materials into the treating vessel.

JP-A-2002-305189, for example, proposes another vertical-type heat treatment apparatus, which is equipped with an air blower to forcibly air-cool a treating vessel by supplying air to the inside of a furnace body including a heater. The blower has been used for rapidly cooling wafers and the treating vessel after heat treatment.

Heat treatment processes include heat-treating wafers in a low-temperature region of, for example, 100 to 500° C., for a purpose such as forming a layer of a low dielectric constant. During the heat treatment in the low-temperature region, it becomes important how fast the furnace interior can be heated up or cooled down to a predetermined heat-treating temperature. An existing heat-treatment apparatus proposed for low-temperature applications includes a metallic treating chamber, not a quartz-made treating vessel, to obtain faster thermal response. However, if reaction products, by-products, or other substances are likely to stick to the furnace interior during the heat treatment, the use of a quartz-made treating vessel easier to clean and replace than a metallic treating chamber is necessary for reasons associated with the apparatus configuration. Additionally, although energy saving in the apparatus is achievable by using a heater having high heat-insulating performance, the use of the heater deteriorates the furnace in the controllability of internal temperature. In this case, it also becomes important how fast the furnace interior can be heated up or cooled down to a predetermined heat-treating temperature, and this issue also applies to temperatures other than those of the low-temperature region discussed above.

### RELATED DOCUMENTS

Document 1: JP-A-2002-305189
Document 2: JP-A-2005-188869

The vertical-type heat treatment apparatus with a quartz-made treating vessel, however, has had a problem in that the settling time required for the furnace interior to recover from the heated state in the low-temperature region and settle down to a desired temperature tends to increase since the treating vessel has a large heat capacity. The same problem due to using a highly adiabatic heater for purposes such as energy saving, also occurs in temperature regions other than low-temperature regions. The above-discussed increase in settling time during the recovery from the heated state is influential upon the improvement of throughput. The problem of the increase in settling time occurs not only in the heating process, but also in a cooling process or under temperature stability.

### SUMMARY OF THE INVENTION

The present invention has been made with the above problem taken into account, and an object of the invention is to provide a heat treatment apparatus and, a method for controlling the apparatus, the apparatus being able to reduce a settling time required in a heating or cooling phase or stable temperature state during use of a heater in a low-temperature region or having high heat-insulating performance, and to settle down an internal temperature of a treating vessel to a target temperature very accurately.

A heat treatment apparatus according to a first aspect of the present invention includes: a furnace body; a heater provided on an inner circumferential surface of the furnace body; a treating vessel disposed inside the furnace body, the treating vessel forming a space between the furnace body and the vessel and internally accommodating a plurality of objects to be processed; a blower, connected to the furnace body, for supplying a cooling medium to the space formed between the furnace body and the treating vessel; a temperature sensor that detects internal temperature or external temperature of the treating vessel; and a controller that regulates the internal temperature of the treating vessel by controlling the heater and the blower in order to settle down the internal temperature of the treating vessel to a predetermined target temperature, wherein the controller includes: a heater output computing unit that determines a heater output level to be obtained during temperature regulation with the heater only, the heater output level being based on a preset temperature and the temperature detected by the temperature sensor; and a blower output computing unit that determines a blower output level based on the heater output level determined by the heater output computing unit.

In the heat treatment apparatus according to the first aspect, the blower output computing unit activates blower output when the heater output level determined by the heater output computing unit decreases below zero, and deactivates blower output when the heater output level becomes equal to or exceeds zero.

In the heat treatment apparatus according to the first aspect, the blower output computing unit activates blower output when a gradient of the heater output level determined by the heater output computing unit falls below a threshold level, and deactivates blower output when the gradient of the heater output level outstrips a threshold level.

In the heat treatment apparatus according to the first aspect, the controller further includes a flow control computing unit that converts the blower output level determined by the blower output computing unit, into a flow rate of the cooling medium.

In the heat treatment apparatus according to the first aspect, the flow control computing unit controls a rotating speed of the blower based on the flow rate of the cooling medium.

A control method according to a second aspect of the present invention relates to a heat treatment apparatus including a furnace body; a heater provided on an inner circumferential surface of the furnace body; a treating vessel disposed inside the furnace body, the treating vessel forming a space between the furnace body and the vessel itself and internally accommodating a plurality of objects to be processed; a blower, connected to the furnace body, for supplying a cooling medium to the space formed between the furnace body and the treating vessel; a temperature sensor that detects internal temperature or external temperature of the treating vessel; and a controller that regulates the internal temperature of the treating vessel by controlling the heater and the blower in order to settle down the internal temperature of the treating vessel to a predetermined target temperature; wherein the controller includes: a heater output computing unit that determines a heater output level to be obtained during temperature regulation with the heater only, the heater output level being based on a preset temperature and the temperature detected by the temperature sensor; and a blower output computing unit that determines a blower output level based on the heater output level determined by the heater output computing unit, the control method including the steps of: determining, by the heater output computing unit in the controller, the heater output level to be obtained during temperature regulation with the heater only, the heater output level being based on the preset temperature and the temperature detected by the temperature sensor; and determining, by the blower output computing unit, the blower output level based on the heater output level determined by the heater output computing unit.

In the heat treatment apparatus control method according to the second aspect, the blower output computing unit activates blower output when the heater output level determined by the heater output computing unit decreases below zero, and deactivates blower output when the heater output level becomes equal to or exceeds zero.

In the heat treatment apparatus control method according to the second aspect, the blower output computing unit activates blower output when a gradient of the heater output level determined by the heater output computing unit falls below a threshold level, and deactivates blower output when the gradient of the heater output level outstrips a threshold level.

The heat treatment apparatus control method according to the second aspect further includes the step of converting the blower output level determined by the blower output computing unit, into a flow rate of the cooling medium by a flow control computing unit.

In the heat treatment apparatus control method according to the second aspect, the flow control computing unit controls a rotating speed of the blower based on the flow rate of the cooling medium.

A heat treatment apparatus according to a third aspect of the present invention includes: a furnace body; a heater provided on an inner circumferential surface of the furnace body; a treating vessel disposed inside the furnace body, the treating vessel forming a space between the furnace body and the vessel and internally accommodating a plurality of objects to be processed; a blower, connected to the furnace body via a cooling medium supply line, for supplying a cooling medium to the space formed between the furnace body and the treating vessel; a valve mechanism that regulates a flow rate of the cooling medium supplied from the blower; a temperature sensor that detects internal temperature or external temperature of the treating vessel; and a controller that regulates the internal temperature of the treating vessel by controlling the heater and the valve mechanism in order to settle down the internal temperature of the treating vessel to a predetermined target temperature; wherein the controller includes: a heater output computing unit that determines a heater output level to be obtained during temperature regulation with the heater only, the heater output level being based on a preset temperature and the temperature detected by the temperature sensor, a cooling output computing unit that determines a cooling output level based on the heater output level determined by the heater output computing unit, and a flow control computing unit that converts the cooling output level determined by the cooling output computing unit, into the flow rate of the cooling medium, the flow control computing unit controlling the valve mechanism in accordance with the flow rate of the cooling medium.

In the heat treatment apparatus according to the third aspect, the cooling output computing unit activates cooling output when the heater output level determined by the heater output computing unit decreases below zero, and deactivates cooling output when the heater output level becomes equal to or exceeds zero.

In the heat treatment apparatus according to the third aspect, the cooling output computing unit activates cooling output when a gradient of the heater output level determined by the heater output computing unit falls below a threshold level, and deactivates cooling output when the gradient of the heater output level outstrips a threshold level.

A control method according to a fourth aspect of the present invention relates to a heat treatment apparatus including a furnace body; a heater provided on an inner circumferential surface of the furnace body; a treating vessel disposed inside the furnace body, the treating vessel forming a space between the furnace body and the vessel itself and internally accommodating a plurality of objects to be processed; a blower, connected to the furnace body via a cooling medium supply line, for supplying a cooling medium to the space formed between the furnace body and the treating vessel; a valve mechanism that regulates a flow rate of the cooling medium supplied from the blower; a temperature sensor that detects internal temperature or external temperature of the treating vessel; and a controller that regulates the internal temperature of the treating vessel by controlling the heater and the valve mechanism in order to settle down the internal temperature of the treating vessel to a predetermined target temperature; wherein the controller includes: a heater output computing unit that determines a heater output level to be obtained during temperature regulation with the heater only, the heater output level being based on a preset temperature and the temperature detected by the temperature sensor, a cooling output computing unit that determines a cooling output level based on the heater output level determined by the heater output computing unit, and a flow control computing unit that converts the cooling output level determined by the cooling output computing unit, into a flow rate of the cooling medium, the flow control computing unit controlling the valve mechanism in accordance with the flow rate of the cooling medium, the control method including the steps of: determining, by the heater output computing unit in the controller, the heater output level to be obtained during temperature regulation with the heater only, the heater output level being based on the preset temperature and the temperature detected by the temperature sensor; determining, by the cooling output computing unit, the cooling output level based on the heater output level determined by the heater output computing unit; and converting, by the flow control computing unit, the cooling output level determined by the cooling output computing unit, into the flow rate of the cooling medium, wherein the flow control computing unit controls the valve mechanism in accordance with the flow rate of the cooling medium.

In the heat treatment apparatus control method according to the fourth aspect, the cooling output computing unit activates cooling output when the heater output level determined by the heater output computing unit decreases below zero, and deactivates cooling output when the heater output level becomes equal to or exceeds zero.

In the heat treatment apparatus control method according to the fourth aspect, the cooling output computing unit activates cooling output when a gradient of the heater output level determined by the heater output computing unit falls below a threshold level, and deactivates cooling output when the gradient of the heater output level outstrips a threshold level.

The present invention can reduce a settling time required for the furnace interior to recover from a heated state in a low-temperature region and settle down to the target temperature very accurately, and thus can improve throughput, or during use of a heater high in heat-insulating performance, reduce electric power consumption without affecting the throughput.

### BRIEF DESCRIPTION OF THE DRAWINGS

FIGS. 1(a) and 1(b) relate to a heat treatment apparatus according to a first embodiment of the present invention, FIG. 1(a) being a longitudinal sectional view schematically showing the apparatus, and FIG. 1(b) being a diagram showing a controller of the heat treatment apparatus;

FIG. 2 is a diagram showing a cooling medium supply line and cooling medium exhaust line of the heat treatment apparatus;

FIGS. 3(a), 3(b), and 3(c) are diagrams relating to control of the heat treatment apparatus;

FIG. 4 is a further diagram relating to the control of the heat treatment apparatus; and

FIG. 5 is a diagram showing a controller of a heat treatment apparatus according to a second embodiment of the present invention.

### DESCRIPTION OF THE PREFERRED EMBODIMENTS

### First Embodiment

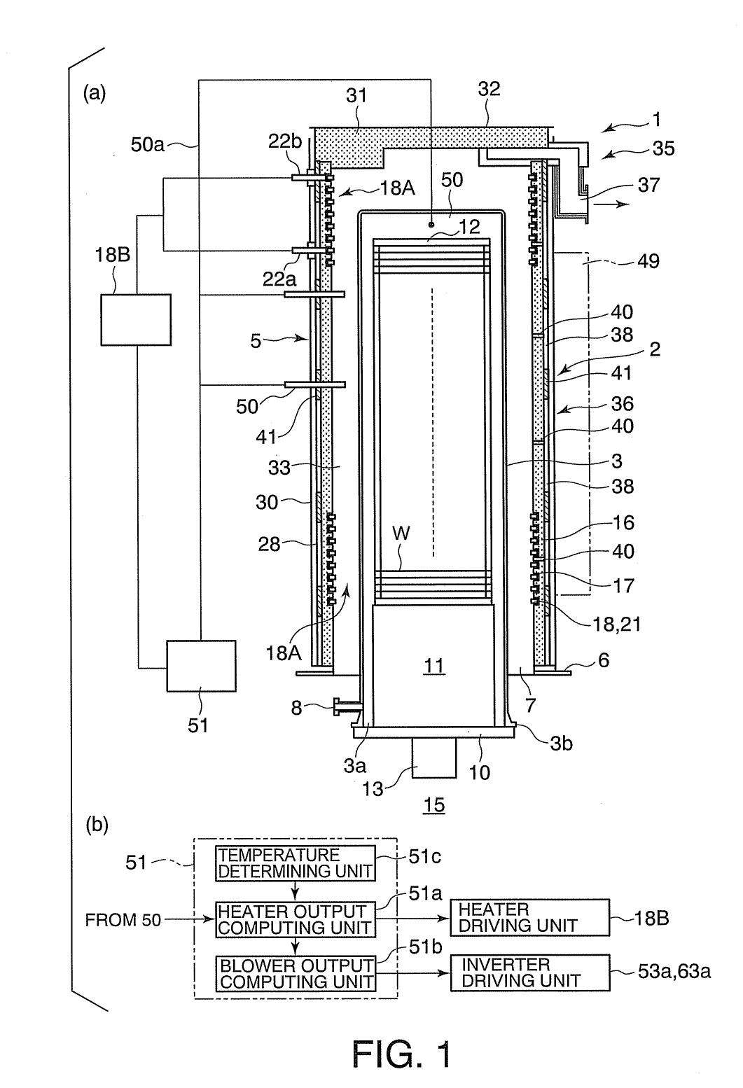

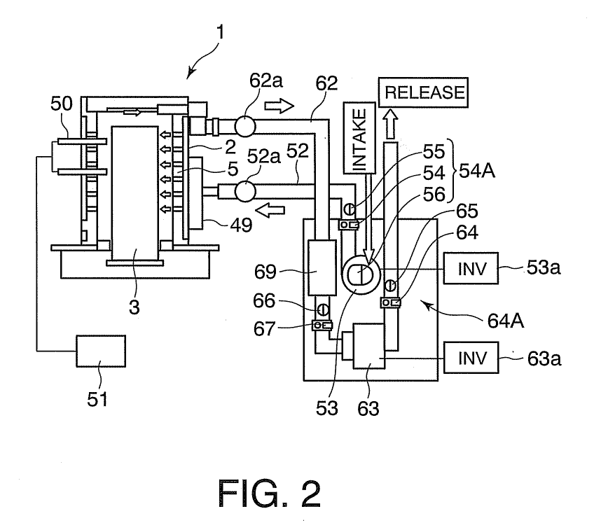

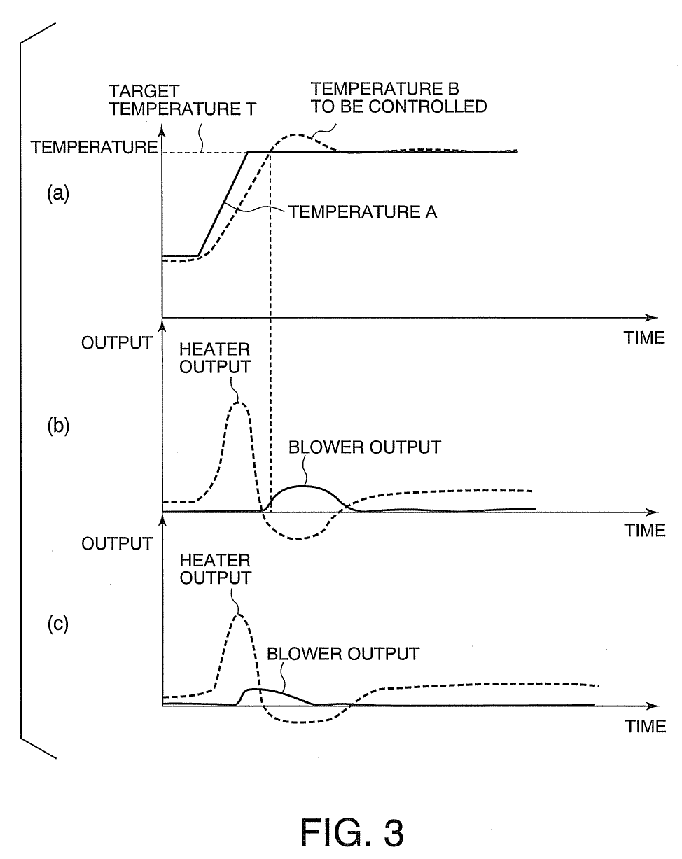

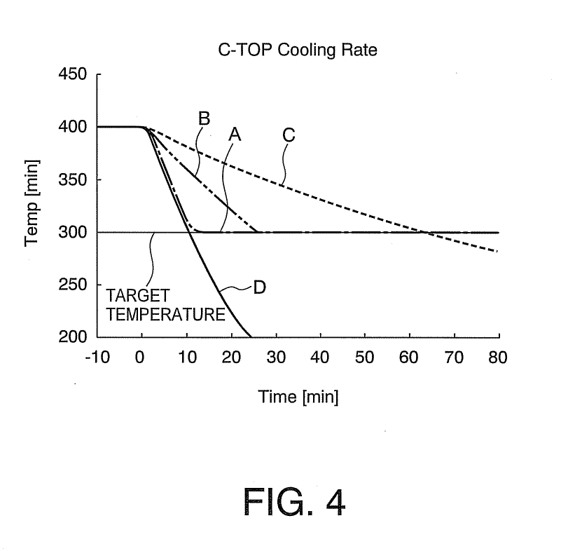

A first embodiment of the present invention is described below referring to the accompanying drawings, wherein FIG. 1(a) is a longitudinal sectional view schematically showing a heat treatment apparatus according to the first embodiment of the present invention, FIG. 1(b) is a diagram showing a controller of the heat treatment apparatus, FIG. 2 is a diagram showing a cooling medium supply line and cooling medium exhaust line of the vertical-type heat treatment apparatus, FIGS. 3(a), 3(b), and 3(c) are diagrams relating to control of the heat treatment apparatus, and FIG. 4 is a further diagram relating to the control of the heat treatment apparatus.

The vertical type of heat treatment apparatus 1 in FIG. 1(a) includes a vertical type of heat treatment furnace 2 that is able to accommodate a large number of objects to be processed, for example, semiconductor wafers W, at a time and to provide each wafer W with heat treatment processes such as oxidizing, diffusing, and/or chemical vapor deposition (CVD) under reduced pressure. The heat treatment furnace 2 includes a furnace body 5 having a resistance heating element (heater) 18A on its inner circumferential surface, and a treating vessel 3 disposed inside the furnace body 5, the treating vessel 3 forming a space between the furnace body 5 and the vessel itself, internally accommodating the wafer W and heat-treating it. The heater 18A is formed by a plurality of heater elements 18, as described later herein.

The furnace body 5 is supported by a base plate 6, in which is formed an opening 7 for inserting the treating vessel 3 from below, in an upward direction. The opening 7 in the base plate 6 includes a heat-insulating material (not shown) for filling up or shrouding a clearance between the base plate 6 and the treating vessel 3.

The treating vessel 3, made of quartz, has a vertically elongated cylindrical shape with a blocked upper end and an opened lower end serving as an opening 3a. At the lower end of the treating vessel 3, an outward-facing flange 3b is formed, which is supported by the base plate 6 via a flange retainer not shown. An induction port 8 for inducting a process gas, an inert gas, and/or the like, into the vessel 3, and an exhaust port (not shown) for releasing the gas or gases from the treating vessel 3 are further provided on a lower section of the treating vessel 3. The induction port 8 is connected to a gas supply (not shown), and the exhaust port is connected to an exhaust system (not shown) that includes a vacuum pump having a pressure reduction control capability to obtain a vacuum pressure ranging, for example, nearly between 133×600 Pa and 133×10⁻² Pa.

Below the treating vessel 3, a lid 10 for blocking the opening 3a of the vessel 3 is provided to be vertically movable by a lift not shown. On an upper section of the lid 10, a cylindrical heat-insulating body 11 as a heat insulator for the opening is mounted, and on an upper section of the cylindrical heat-insulating body 11, a quartz-made boat 12 is mounted as a wafer retainer in which to mount a large number of, for example, about 100 to 150 wafers with a 300-mm diameter vertically at predetermined intervals. A rotating mechanism 13 that rotates the boat 12 about an axial center of the boat is provided on the lid 10. The boat 12 is unloaded from the treating vessel 3 into a loading area 15 provided below, by a downward movement of the lid 10, and after wafer transfer, the boat 12 is loaded into the treating vessel 3 by an upward movement of the lid 10.

The furnace body 5 has a cylindrical heat-insulating material 16 and a shelf 17 of a multiple-tier grooved structure formed axially (in the example of FIG. 1, vertically) on an inner circumferential surface of the heat-insulating material 16, and the heater elements (resistance heating elements) 18 are arranged along the shelf 17. The heat-insulating material 16 is formed from inorganic fibers including, for example, silica, alumina, or aluminum silicate. The heat-insulating material 16 is divided into two sections vertically, thus making it easy to mount the heater elements and to assemble the heater.

The heat-insulating material 16 has pins (not shown) holding the heater elements 18 so that the heater elements 18 is movable in a radial direction at appropriate spatial intervals and prevented from falling from or sliding out of position in the shelf 17. On the inner circumferential surface of the cylindrical heat-insulating material 16, ring-like grooves 21 concentric with the particular inner circumferential surface are formed axially in multi-tier form at predetermined pitches, and the ring-shaped shelf 17 continuous in a circumferential direction is formed between mutually adjacent upper and lower grooves 21. Clearances dimensionally sufficient to permit thermal expansion/contraction and radial movement of the heater element 18 are present between upper and lower sections of each heater element 18 in the grooves 21, a rear wall of each groove 21, and the heater element 18. These clearances also allow a cooling medium to flow around to the rear of the heater element 18 during forced cooling to effectively cool the element 18. Air, a nitrogen gas, or water is useable as the cooling medium.

Each heater element 18 is interconnected by a connecting plate, the heater elements 18 positioned in one end of the furnace 2 are further connected to an external heater-driving unit 18B via terminal strips 22a or 22b provided so as to penetrate the heat-insulating material 16 in its radial direction.

As shown in FIG. 1(a), the heat-insulating material 16 has an outer circumferential surface shrouded by a metallic, for example, stainless steel outer shell 28, to retain a shape of the heat-insulating material 16 in the furnace body 5 and to strengthen the heat-insulating material 16. Additionally, the outer shell 28 has an outer circumferential surface shrouded by a water-cooling jacket 30 to suppress thermal impacts upon the outside of the furnace body 5. The heat-insulating material 16 further has a top shrouded with an upper heat-insulating material 31, over which a top plate 32 made of stainless steel is further provided to shroud a top (upper end) of the outer shell 28.

As shown in FIGS. 1(a) and 2, in order to expedite the heat treatment or improve throughput by rapidly cooling down the wafers after the heat treatment, the furnace body 5 further includes a heat release system 35 and forced-cooling medium means 36. The heat release system 35 releases an internal atmosphere of the space 33 between the furnace body 5 and the treating vessel 3 to the outside, and the forced-cooling medium means 36 introduces the cooling medium of a normal temperature (20 to 30° C.) into the space 33 and forcibly cools the furnace interior. The heat release system 35 includes a heat release port 37 provided, for example, at an upper section of the furnace body 5, and a cooling medium release line 62, provided with a flow sensor 62a, for releasing the cooling medium from the space 33 is connected to the heat release port 37.

Furthermore, the forced-cooling medium means 36 includes a plurality of ring-shaped passageways 38 formed vertically between the heat-insulating material 16 and outer shell 28 of the furnace body 5, and cooling medium blowoff holes 40 provided in the heat-insulating material 16. The cooling medium blowoff holes 40 are constructed to blow off the cooling medium from each ring-shaped passageway 38, in an oblique direction from a central section of the heat-insulating material 16, and generate a swirling flow in a circumferential direction of the space 33. The ring-shaped passageway 38 is formed by, for example, affixing a band form or ring form of heat insulator 41 to an outer circumferential surface of the heat-insulating material 16 or circularly grinding away the outer circumferential surface of the heat-insulating material 16. The cooling medium blowoff holes 40 are formed in the shelf 17, with each groove of the shelf sandwiched between upper and lower adjacent heater elements 18 in the heat-insulating material 16, so as to extend through to the inside and outside of the shelf in its radial direction. In this way, the cooling medium blowoff holes 40 are provided in the shelf 17, so the cooling medium can be jetted towards the space 33 without being obstructed by each heater element 18.

While an example of using resistance heating elements of a band form as the heater elements 18 and accommodating these elements in the shelf 17 has been described, the heating elements 18 is not limited to the described structure and may be replaced by any one of various other heater element structures. In addition, although an example of generating a swirling flow in the space 33 by means of the cooling medium from the cooling medium blowoff holes 40 has been described, the cooling medium from the cooling medium blowoff holes 40 does not always need to be used to generate the swirling flow.

One common supply duct 49 for distributing the cooling medium to each ring-shaped passageway 38 is provided in a vertical direction along an outer circumferential surface of the outer shell 28. Ports for establishing communication between the supply duct 49 and each ring-shaped passageway 38 are also formed in the outer shell 28. A cooling medium supply line 52 that supplies the cooling medium and includes a flow sensor 52a is connected to the supply duct 49.

A temperature sensor 50 that detects an internal temperature of the treating vessel 3 is disposed inside the vessel 3, and a detection signal from the temperature sensor 50 is sent to the controller 51 via a signal line 50a. The temperature sensor 50 does not absolutely need to be provided inside the treating vessel 3 and may instead be provided inside the space 33 between the furnace body 5 and the treating vessel 3 or inside both.

As shown in FIGS. 1(a) and 2, the cooling medium supply line 52 and the cooling medium release line 62 each constitute an open cooling medium supply/release line independently. A cooling medium supply blower 53 is provided on the cooling medium supply line 52, and the cooling medium supply blower 53 includes an inverter driving unit 53a.

The cooling medium supply blower 53 has a damper 56 at its inlet side, and a hole valve 54 and a butterfly valve 55, at its outlet side. The damper 56 at the inlet side of the cooling medium supply blower 53, and the hole valve 54 and butterfly valve 55 at the outlet side are all adjustable in opening/closing angle position. The damper 56, the hole valve 54, and the butterfly valve 55 constitute a cooling-medium supply line valve mechanism 54A.

A cooling medium release blower 63 is provided on the cooling medium release line 62, and the cooling medium release blower 63 includes an inverter driving unit 63a.

The cooling medium release blower 63 has a butterfly valve 66 and a hole valve 67, at its inlet side, and a hole valve 64 and a butterfly valve 65, at its outlet side. The butterfly valve 66 and hole valve 67 at the inlet side of the cooling medium release blower 63, and the hole valve 64 and butterfly valve 65 at the outlet side are all adjustable in opening/closing angle position. The butterfly valve 66, the hole valve 67, the hole valve 64, and the butterfly valve 65 constitute a cooling-medium release line valve mechanism 64A.

Next, the controller 51 connected to the temperature sensor 50 is described in detail below.

As described above, the temperature sensor 50 is provided inside the treating vessel 3 to detect the internal temperature of the vessel 3. However, the temperature sensor 50 may instead be mounted in the space 33 between the furnace body 5 and the treating vessel 3, to detect the internal temperature of the vessel 3 indirectly.

The detection signal from the temperature sensor 50 is sent to the controller 51 via the signal line 50a. The controller 51 reduces a time required for the apparatus to heat up or cool down the treating vessel interior to a predetermined target temperature accurately during heating or cooling or under temperature stability, in a low-temperature region of, for example, 100 to 500° C. FIG. 1(b) shows a diagram relating to heating/cooling control by the controller 51.

That is, the controller 51 includes a heater output computing unit 51a for determining a heater output level obtained during temperature regulation with the heater 18A only, on the basis of the temperature detected by the temperature sensor 50 and a temperature preassigned by a temperature determining unit 51c. The controller 51 also includes a blower output computing unit 51b for determining a blower output level of the blower based on the heater output level determined by the heater output computing unit 51a.

In order to settle down (converge) the interior of the treating vessel 3 to a target temperature to be obtained in the heating phase by heating up the interior of the treating vessel 3, the temperature determining unit 51c determines temperature A as a temperature level to be set (see FIGS. 3(a), 3(b), 3(c)). After the determination of temperature A by the temperature determining unit 51c, the value is sent to the heater output computing unit 51a.

In addition, after the calculation of the heater output level by the heater output computing unit 51a, the value is sent to the heater driving unit 18B, by which the heater element 18 of the heater 18A is then drivingly controlled according to that heater output level.

Meanwhile, after the calculation of the blower output level by the blower output computing unit 51b, the value is sent to the inverter driving units 53a, 63a, by which the cooling medium supply blower 53 and the cooling medium release blower 63 are then drivingly controlled.

In this manner, the cooling medium supply blower 53 and the cooling medium release blower 63 supply the cooling medium to the space 33 between the furnace body 5 and the treating vessel 3.

While an example of supplying the cooling medium to the space 33 between the furnace body 5 and the treating vessel 3 by providing the cooling medium supply blower 53 and the cooling medium release blower 63 has been described, the cooling medium may be supplied to the space 33 between the furnace body 5 and the treating vessel 3 by providing only either one of the cooling medium supply blower 53 and the cooling medium release blower 63. In this case, a closed cooling-medium supply/release line may be formed by connecting both of the cooling medium supply line and the cooling medium release line to the blower. For example, if the cooling medium supply blower 53 only is provided, the inverter driving unit 53a of the cooling medium supply blower 53 will be drivingly controlled according to the blower output level computed by the blower output computing unit 51b.

Next, operation of the heat treatment apparatus having the configuration shown in FIG. 1 is described below.

First, wafers W are mounted in the boat 12 and then this boat is rested on the cylindrical heat-insulating body 11. The boat 12 is later loaded into the treating vessel 3 by upward movement of the lid 10.

Next, the controller 51 controls the heater driving unit 18B to activate the heater element 18, heat the space 33 between the furnace body 5 and the treating vessel 3, and thus conduct a necessary heat treatment upon the wafers W mounted in the boat 12 of the treating vessel 3.

During the heat treatment, as described below, the space 33 between the furnace body 5 and the treating vessel 3 is forcibly cooled when necessary, to improve efficiency of the heat treatment.

In that case, the controller 51 first activates the cooling medium supply blower 53 and the cooling medium release blower 63. A cooling medium (20 to 30° C.) is then introduced into the cooling medium supply line 52 and next carried from the cooling medium supply blower 53 to the supply duct 49.

The cooling medium in the supply duct 49 enters each ring-shaped passageway 38 formed outward with respect to the heat-insulating material 16 of the furnace body 5. Next, the cooling medium in the ring-shaped passageways 38 is blown off from the cooling medium blowoff holes 40 passed through the heat-insulating material 16, into the space 33 between the furnace body 5 and the treating vessel 3, thereby forcibly cooling the space 33.

The cooling medium in the space 33 is further carried into a heat exchanger 69 through the cooling medium release line 62, then cooled by the heat exchanger 69, and released to the outside by the cooling medium release blower 63.

Next, the control that the controller 51 conducts to heat up or cool down the interior of the treating vessel 3 to the predetermined target temperature T by regulating the internal temperature of the vessel 3 is described in further detail below per FIGS. 3(a), 3(b), 3(c).

FIG. 3(a) is a graph representing a relationship between the predetermined target temperature, temperature preassigned by the temperature determining unit 51c, and a temperature to be controlled (the temperature detected by the temperature sensor 50). FIG. 3(b) is a graph representing a first method of control by the controller 51, and FIG. 3(c) is a graph representing a second method of control by the controller 51.

The first method of control by the controller 51 is first described below per FIGS. 3(a), 3(b). As shown in FIGS. 3(a), 3(b), the temperature determining unit 51c of the controller 51 determines temperature A to attain the predetermined target temperature T during heating or cooling in the low-temperature region.

Next, temperature A determined by the temperature determining unit 51c is input to the heater output computing unit 51a, in which the heater output level to be obtained during temperature regulation with the heater 18A only is computed from temperature A determined by the temperature determining unit 51c and the temperature B detected by the temperature sensor 50.

Next as shown in FIG. 3(b), the heater output value that has been computed by the heater output computing unit 51a is sent to the blower output computing unit 51b.

If the heater output value is minus, the blower output computing unit 51b determines a blower output pattern nearly symmetrical to the minus heater output pattern.

In the case of the minus heater output, the blower output computing unit 51b needs only to determine a blower output pattern corresponding to the minus heater output pattern, and the heater output pattern and blower output pattern in that case do not absolutely need to be symmetrical to each other.

Next, the heater driving unit 18B conducts driving control of the heater 18A, based on the heater output level computed by the heater output computing unit 51a. At the same time, the inverter driving units 53a, 63a conduct driving control of the cooling medium supply blower 53 and cooling medium release blower 63 by controlling respective rotational speeds in accordance with the blower output level computed by the blower output computing unit 51b.

In this way, the heater driving unit 18B conducts driving control of the heater 18A in accordance with the heater output level computed by the heater output computing unit 51a, if the heater output value becomes minus, the blower output computing unit 51b generates (activates) the blower output level based on the minus heater output pattern, and when the heater output value becomes equal to or exceeds zero, the blower output computing unit 51b stops of generating (deactivates) blower output. Thus, temperature B to be controlled can be accurately brought close to temperature A. At the same time, the internal temperature of the treating vessel is rapidly raised or lowered to (converged to) the predetermined target temperature.

In addition to using a heater output level of zero as a threshold to determine the blower output level based on the minus output pattern, the blower output computing unit 51b may correct that threshold level with a predetermined offset value to determine the blower output level.

Next, the second method of control by the controller 51 is described below per FIGS. 3(a), 3(c). As shown in FIGS. 3(a), 3(c), the temperature determining unit 51c of the controller 51 determines temperature A to attain the predetermined target temperature T during heating or cooling in the low-temperature region.

Next, temperature A determined by the temperature determining unit 51c is input to the heater output computing unit 51a, in which the heater output level to be obtained during temperature regulation with the heater 18A only is computed from temperature A determined by the temperature determining unit 51c and temperature B detected by the temperature sensor 50.

Next as shown in FIG. 3(c), the heater output value that has been computed by the heater output computing unit 51a is sent to the blower output computing unit 51b.

The blower output computing unit 51b determines the blower output level so as to activate blower output when a gradient of the heater output level falls below zero, and deactivate blower output when the gradient of the heater output level becomes equal to or exceeds zero.

Next, the heater driving unit 18B conducts driving control of the heater 18A, based on the heater output level computed by the heater output computing unit 51a. At the same time, the inverter driving units 53a, 63a conduct driving control of the cooling medium supply blower 53 and cooling medium release blower 63 by controlling respective rotational speeds in accordance with the blower output level computed by the blower output computing unit 51b.

In this way, the heater driving unit 18B conducts driving control of the heater 18A in accordance with the heater output level computed by the heater output computing unit 51a, if the gradient of the heater output level becomes minus, the blower output computing unit 51b generates the blower output level based on the minus heater output pattern, and when the gradient of the heater output level becomes equal to or exceeds zero, the blower output computing unit 51b deactivates blower output. Thus, temperature B to be controlled can be accurately brought close to temperature A. At the same time, the internal temperature of the treating vessel is rapidly raised or lowered to the predetermined target temperature.

In addition to using heater output gradient zero as a threshold to determine the blower output level based on the minus output pattern, the blower output computing unit 51b may correct that threshold level with a predetermined offset value to determine the blower output level.

Next, more specific operation obtained by executing the first control method or second control method by the controller 51 during the cooling phase in the low-temperature region is described below per FIG. 4.

As shown in FIG. 4, for lowering the internal temperature of the treating vessel 3 from a current temperature of 400° C. to 300° C. during the cooling phase in the low-temperature region, the temperature determining unit 51c of the controller 51 determines temperature A first.

The first control method, that is, the control method shown in FIG. 3(b), or the second control method, that is, the control method shown in FIG. 3(c), is executed next. Thus, temperature B to be controlled can be brought close to temperature A and at the same time, the target temperature 300° C. can be reached rapidly and accurately.

This means that if cooling-down is conducted only by turning off the heater at the current temperature of 400° C., although the internal temperature of the treating vessel 3 will decrease to the target temperature of 300° C. (see line C of FIG. 4), the time required for the internal temperature to go down to the target temperature of 300° C. will be long and even after decreasing below 300° C., the internal temperature will continue to further decrease without settling down to 300° C.

Conversely if the heater is turned off at the current temperature of 400° C. and the blower remains operative without being controlled, although the internal temperature of the treating vessel 3 will rapidly descend to the target temperature of 300° C. (see line D of FIG. 4), even after decreasing below 300° C., the internal temperature will continue to further decrease and will not settle down to 300° C.

In contrast to the above, if the first control method or second control method according to the present invention is used, temperature B to be controlled can be brought close to temperature A and at the same time, the target temperature of 300° C. can be reached rapidly and accurately. In addition, temperature B to be controlled can be reliably lowered to the target temperature of 300° C.

It is to be understood that the present invention is not limited to the above-described embodiment and may incorporate various changes in design without departing from the scope of the invention. For example, the treating vessel can include a cylindrical manifold made of such a heat-resistant metal, for example stainless steel, as having an induction pipe and a release pipe, the manifold being connected to a lower end of the vessel, or may be of double-pipe construction.

### Second Embodiment

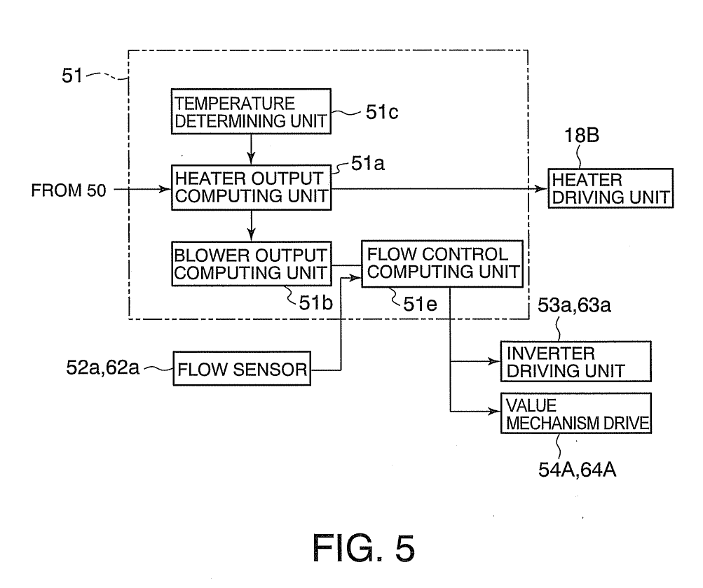

The following describes a second embodiment of the present invention with reference to FIG. 5.

The second embodiment shown in FIG. 5 differs only in a configuration of a controller 51, with substantially all other configurational aspects being substantially the same as in the first embodiment of FIGS. 1 to 4.

In the second embodiment of FIG. 5, the same elements as in the first embodiment of FIGS. 1 to 4 are each assigned the same reference number or symbol, and detailed description of these elements is omitted.

As shown in FIG. 5, the controller 51 includes a heater output computing unit 51a for determining heater output level to be obtained during temperature regulation with a heater 18A only, based on a furnace internal temperature detected by a temperature sensor 50 and a temperature preassigned by a temperature determining unit 51c. The controller 51 also includes a blower output computing unit (cooling output computing unit) 51b for determining a blower output level (cooling output level) based on the heater output level determined by the heater output computing unit 51a.

In addition, the controller 51 includes a flow control computing unit 51e for converting the blower output level (cooling output level) that has been determined by the blower output computing unit 51b, into a flow rate of a cooling medium.

In this case, the flow control computing unit 51e converts the blower output level into an appropriate flow rate of the cooling medium supplied to a space 33 between a furnace body 5 and a treating vessel 3.

The heater output computing unit 51a in FIG. 5 determines the heater output level to be obtained during temperature regulation with the heater 18A only, based on the furnace internal temperature detected by the temperature sensor 50. The blower output computing unit 51b computes the blower output level based on the heater output level determined by the heater output computing unit 51a.

Furthermore, the flow control computing unit 51e converts the blower output level computed by the blower output computing unit 51b, into a flow rate of the cooling medium and then outputs inverter driving signals based on this flow rate of the cooling medium and on cooling medium flow rates in a cooling medium supply line 52 and a cooling medium release line 62, the flow rates being detected by flow sensors 52a and 62a. After that, based on the inverter driving signals computed by the flow control computing unit 51e, inverter driving units 53a and 63a conduct driving control of a cooling medium supply blower 53 and a cooling medium release blower 63 by controlling respective rotational speeds. The cooling medium flow rates in the cooling medium supply line 52 and the cooling medium release line 62 are thus controlled.

In this way, the flow control computing unit 51e converts the blower output level computed by the blower output computing unit 51b, into the flow rate of the cooling medium to be supplied to the space 33 between the furnace body 5 and the treating vessel 3, and controls the cooling medium flow rates detected by the flow sensors 52a, 62a. Therefore, even if the cooling medium supply line 52 and cooling medium release line 62 of the heat treatment apparatus 1 according to the present embodiment differ from each other in terms of arrangement and/or shape, a desired quantity of cooling medium can be supplied to the space 33 between the furnace body 5 and the treating vessel 3. The differences in arrangement and/or shape between the lines 52, 62, include, for example, a difference in length of the line, and more specifically, apply to the case in which either of the two lines is longer or shorter than the other.

Thus, the internal temperature of the furnace can always be controlled with high accuracy, irrespective of the arrangement and/or shape of the cooling medium supply line 52 and cooling medium release line 62 in the heat treatment apparatus 1.

The above has described an example in which the cooling medium supply blower 53 and the cooling medium release blower 63 are drivingly controlled in accordance with the cooling medium flow rate computed by the flow control computing unit 51e. It is to be understood, however, that the described example does not limit the scope of the present invention. That is, driving control of a valve mechanism 54A provided on the cooling medium supply line may be based on the cooling medium flow rate computed by the flow control computing unit 51e, or driving control of a valve mechanism 64A provided on the cooling medium release line may be based on the cooling medium flow rate computed by the flow control computing unit 51e. The above has also described an example in which the flow control computing unit 51e derives the cooling medium flow rate by converting the blower output level (cooling output level) and controls the cooling medium flow rates detected by the flow sensors 52a, 62a. However, the control may be conducted using the cooling medium flow rate detected by one of the flow sensors 52a, 62a.

What is claimed is:

1. A heat treatment apparatus comprising:
a furnace body;
a heater provided on an inner circumferential surface of the furnace body;
a treating vessel disposed inside the furnace body, the treating vessel forming a space between the furnace body and the vessel and internally accommodating a plurality of objects to be processed;
a blower, connected to the furnace body, for supplying a cooling medium to the space formed between the furnace body and the treating vessel;
a temperature sensor that detects internal temperature or external temperature of the treating vessel; and
a controller that regulates the internal temperature of the treating vessel by controlling the heater and the blower in order to settle down the internal temperature of the treating vessel to a predetermined target temperature;
wherein the controller includes:
a heater output computing unit that determines a heater output level to be obtained during temperature regulation with the heater only, the heater output level being based on a preset temperature and the temperature detected by the temperature sensor; and
a blower output computing unit that determines a blower output level based on the heater output level determined by the heater output computing unit.

2. The heat treatment apparatus according to claim 1, wherein the blower output computing unit activates blower output when the heater output level determined by the heater output computing unit decreases below zero, and deactivates blower output when the heater output level becomes equal to or exceeds zero.

3. The heat treatment apparatus according to claim 1, wherein the blower output computing unit activates blower output when a gradient of the heater output level determined by the heater output computing unit falls below a threshold level, and deactivates blower output when the gradient of the heater output level outstrips a threshold level.

4. The heat treatment apparatus according to claim 1, wherein the controller further includes a flow control computing unit that converts the blower output level determined by the blower output computing unit, into a flow rate of the cooling medium.

5. The heat treatment apparatus according to claim 4, wherein the flow control computing unit controls a rotating speed of the blower based on the flow rate of the cooling medium.

6. A method for controlling a heat treatment apparatus, the apparatus including a furnace body; a heater provided on an inner circumferential surface of the furnace body; a treating vessel disposed inside the furnace body, the treating vessel forming a space between the furnace body and the vessel itself and internally accommodating a plurality of objects to be processed; a blower, connected to the furnace body, for supplying a cooling medium to the space formed between the furnace body and the treating vessel; a temperature sensor that detects internal temperature or external temperature of the treating vessel; and a controller that regulates the internal temperature of the treating vessel by controlling the heater and the blower in order to settle down the internal temperature of the treating vessel to a predetermined target temperature, wherein the controller includes: a heater output computing unit that determines a heater output level to be obtained during temperature regulation with the heater only, the heater output level being based on a preset temperature and the temperature detected by the temperature sensor; and a blower output computing unit that determines a blower output level based on the heater output level determined by the heater output computing unit, the control method comprising the steps of:
determining, by the heater output computing unit in the controller, the heater output level to be obtained during temperature regulation with the heater only, the heater output level being based on the preset temperature and the temperature detected by the temperature sensor; and
determining, by the blower output computing unit, the blower output level based on the heater output level determined by the heater output computing unit.

7. The heat treatment apparatus control method according to claim 6, wherein the blower output computing unit activates blower output when the heater output level determined by the heater output computing unit decreases below zero, and deactivates blower output when the heater output level becomes equal to or exceeds zero.

8. The heat treatment apparatus control method according to claim 6, wherein the blower output computing unit activates blower output when a gradient of the heater output level determined by the heater output computing unit falls below a threshold level, and deactivates blower output when the gradient of the heater output level outstrips a threshold level.

9. The heat treatment apparatus control method according to claim 6, further comprising the step of converting the blower output level determined by the blower output computing unit, into a flow rate of the cooling medium by a flow control computing unit.

10. The heat treatment apparatus control method according to claim 9, wherein the flow control computing unit controls a rotating speed of the blower based on the flow rate of the cooling medium.

11. A heat treatment apparatus comprising:
a furnace body;
a heater provided on an inner circumferential surface of the furnace body;
a treating vessel disposed inside the furnace body, the treating vessel forming a space between the furnace body and the vessel and internally accommodating a plurality of objects to be processed;
a blower, connected to the furnace body via a cooling medium supply line, for supplying a cooling medium to the space formed between the furnace body and the treating vessel;
a valve mechanism that regulates a flow rate of the cooling medium supplied from the blower;
a temperature sensor that detects internal temperature or external temperature of the treating vessel; and
a controller that regulates the internal temperature of the treating vessel by controlling the heater and the valve mechanism in order to settle down the internal temperature of the treating vessel to a predetermined target temperature;
wherein the controller includes:
a heater output computing unit that determines a heater output level to be obtained during temperature regulation with the heater only, the heater output level being based on a preset temperature and the temperature detected by the temperature sensor,
a cooling output computing unit that determines a cooling output level based on the heater output level determined by the heater output computing unit, and
a flow control computing unit that converts the cooling output level determined by the cooling output computing unit, into a flow rate of the cooling medium, the flow control computing unit controlling the valve mechanism in accordance with the flow rate of the cooling medium.

12. The heat treatment apparatus according to claim 11, wherein the cooling output computing unit activates cooling output when the heater output level determined by the heater output computing unit decreases below zero, and deactivates cooling output when the heater output level becomes equal to or exceeds zero.

13. The heat treatment apparatus according to claim 11, wherein the cooling output computing unit activates cooling output when a gradient of the heater output level determined by the heater output computing unit falls below a threshold level, and deactivates cooling output when the gradient of the heater output level outstrips a threshold level.

14. A method for controlling a heat treatment apparatus, the apparatus including a furnace body; a heater provided on an inner circumferential surface of the furnace body; a treating vessel disposed inside the furnace body, the treating vessel forming a space between the furnace body and the vessel and internally accommodating a plurality of objects to be processed; a blower, connected to the furnace body via a cooling medium supply line, for supplying a cooling medium to the space formed between the furnace body and the treating vessel; a valve mechanism that regulates a flow rate of the cooling medium supplied from the blower; a temperature sensor that detects internal temperature or external temperature of the treating vessel; and a controller that regulates the internal temperature of the treating vessel by controlling the heater and the valve mechanism in order to settle down the internal temperature of the treating vessel to a predetermined target temperature; wherein the controller includes: a heater output computing unit that determines a heater output level to be obtained during temperature regulation with the heater only, the heater output level being based on a preset temperature and the temperature detected by the temperature sensor, a cooling output computing unit that determines a cooling output level based on the heater output level determined by the heater output computing unit, and a flow control computing unit that converts the cooling output level determined by the cooling output computing unit, into a flow rate of the cooling medium, the flow control computing unit controlling the valve mechanism in accordance with the flow rate of the cooling medium, the control method comprising the steps of:
determining, by the heater output computing unit in the controller, the heater output level to be obtained during temperature regulation with the heater only, the heater output level being based on the preset temperature and the temperature detected by the temperature sensor;
determining, by the cooling output computing unit, the cooling output level based on the heater output level determined by the heater output computing unit; and
converting, by the flow control computing unit, the cooling output level determined by the cooling output computing unit, into the flow rate of the cooling medium, the flow control computing unit controlling the valve mechanism in accordance with the flow rate of the cooling medium.

15. The heat treatment apparatus control method according to claim 14, wherein the cooling output computing unit activates cooling output when the heater output level determined by the heater output computing unit decreases below zero, and deactivates cooling output when the heater output level becomes equal to or exceeds zero.

16. The heat treatment apparatus control method according to claim 14, wherein the cooling output computing unit activates cooling output when a gradient of the heater output level determined by the heater output computing unit falls below a threshold level, and deactivates cooling output when the gradient of the heater output level outstrips a threshold level.
